(19) United States
(12) Patent Application Publication
(10) Pub. No.: US 2016/0227753 A1
(43) Pub. Date: Aug. 11, 2016

(54) INSECT TRAP HAVING A REMOVABLE AND REPLACEABLE FLOOR

(71) Applicant: BED BUG CENTRAL, LLC, Lawrenceville, NJ (US)

(72) Inventors: Jeffrey C. White, New Egypt, NJ (US); Philip Cooper, Yardley, PA (US); Sean M. Kelley, Yorba Linda, CA (US)

(73) Assignee: Bed Bug Central, LLC, Lawrenceville, NJ (US)

(21) Appl. No.: 15/028,511

(22) PCT Filed: Oct. 10, 2014
(86) PCT No.: PCT/US14/60092

§ 371 Date: Apr. 11, 2016

Related U.S. Application Data
(60) Provisional application No. 61/889,650, filed on Oct. 11, 2013.

(51) Int. Cl. A01M 1/10; A01M 99/00; A01M 1/02; A01M 1/14; A01M 1/20

(52) U.S. Cl. CPC A01M 1/10; A01M 1/14; A01M 1/2005; A01M 1/02; A01M 99/00

(57) ABSTRACT

Hollow body insect traps with a continuous sidewall and a detachable base defining a truncated pyramid or a truncated cone shape, wherein the apex of the truncated cone or pyramid has a top surface defining an inlet communicating the interior of the hollow body with the exterior environment. Package systems, accessory packages, insect trapping kits and methods for monitoring insects are also disclosed.

### CROSS-REFERENCE TO RELATED APPLICATION

The present application claims priority benefit under 35 U.S.C. §119(e) to U.S. Provisional Application Serial No. 61/889,650 filed Oct. 11, 2013, the disclosure of which is incorporated herein by reference.

### BACKGROUND OF THE INVENTION

1. Statement of the Technical Field

The present paragraph relates to insect traps. More specifically, the present paragraph relates to an insect trap having a removable and replaceable floor feature.

2. Description of the Related Art

Insect traps typically use geometric designs to overcome the natural abilities of insects in order to trap the insects within the trap. For example, many insect traps lure insect through a small hole into a large enclosure. A cone or funnel-shape inlet leads between the hole to the enclosure, limiting the insects' ability to exit from the enclosure. Insects are typically attracted to the enclosure by either light or chemical attractants such as chemicals that emit a food related odor. The enclosure may include glue covered surfaces, poisonous chemicals, and/or other means for incapacitating the insects.

In a typical insect trap, the design relies upon the insects' inability to navigate the inlet between the hole and the enclosure to escape. However, additional design features such as slanted or inverted walls are also used to prevent an insect from crawling up the outside walls of the enclosure. Such an example of an inverted wall is shown in U.S. Pat. No. 5,253,450 to Muramatsu, the content of which is hereby incorporated by reference in its entirety. In the Muramatsu design, a trap is formed by cutting and folding blanks of a pliable material into a hollow chamber having slanted walls. A tubular inlet is used to lead the insects into the enclosure, where poison, glue or another incapacitating means is provided.

Existing insect traps, including the improved design of Muramatsu, all have various drawbacks. Primarily, the traps do not provide for reuse, which leads to a higher cost of use as the entire trap is continually replaced, as well as increased waste product resulting from the disposed traps as well as the packaging materials associated therewith.

### SUMMARY OF THE INVENTION

Having recognized the shortcomings in existing insect traps, the present invention provides an improved insect trap having a lower cost and a lower weight option to existing designs, while still providing a high capture-rate. The improved insect trap has a hollow body with a continuous sidewall and a detachable base defining a hollow truncated pyramid or a hollow truncated cone shape, wherein the apex of the truncated cone or pyramid has a top surface defining an inlet of the hollow body.

In some embodiments of the present invention, the material used to form the trap may be polylactide, polyester, polyethylene terephthalate, polyethylene, polyvinyl chloride, poly-vinylidene chloride, polypropylene, polystyrene, polyamides, acrylonitrile butadiene styrene, polycarbonate, polyurethane, polyacrylate and a combination thereof. In some embodiments, the walls have uniform thickness that provides for easier tooling and material versatility during the manufacturing process.

In another aspect, the present invention provides for a fully nestable trap package system that reduces the overall size of packaging required for shipping the insect trap.

In another aspect, the present invention provides an insect trap kit containing the insect trap of the present invention, an absorbent material with an insect trapping composition, and instructions for use of the insect trap. The insect trapping composition may be one or more of pressure sensitive adhesives, poisons, and odor emitting insect lures. An accessory package is also provided containing an absorbent material and an insect trapping composition absorbed thereon, wherein the package has a barrier layer preventing release of the insect trapping composition.

Another aspect of the present invention provides a method of monitoring insects by inserting an absorbent material with an insect trapping composition absorbed thereon, into the hollow body of the insect trap of the present invention, and placing said insect trap in a desired location.

The present objectives, features and advantages will be apparent from the following detailed description of the invention, which is to be read in conjunction with the accompanying drawings. The scope of the invention will be pointed out in the claims. The following drawings, taken in conjunction with the subsequent description, are presented to enable one of ordinary skill in the art to make and use the invention and to incorporate it in the context of particular applications.

### BRIEF DESCRIPTION OF THE DRAWINGS

Embodiments will be described with reference to the following drawing figures, in which like numerals represent like items through the figures, and in which:

FIG. 1 depicts a profile view of an improved insect trap according to an embodiment;

FIG. 2 depicts a cutaway view of the improved insect trap of FIG. 1;

FIG. 3 depicts a cutaway view of the improved insect trap of FIG. 1 including a removable and replaceable floor feature;

FIG. 4 depicts a cutaway view of the improved insect trap of FIG. 1 including an alternative removable and replaceable floor feature;

FIG. 5A depicts a sample packaging scenario of the improved insect trap as disclosed herein;

FIG. 5B depicts a sample packaging scenario for a set of replacement floor features;

FIG. 6A depicts a photograph of an insect trap body according to an embodiment; and

FIG. 6B depicts a photograph of an insect trap removable and replaceable floor component according to an embodiment.

### DETAILED DESCRIPTION

This paragraph is not limited to the particular systems, devices and methods described, as these can vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

The present paragraph relates to an improved insect trap that provides various advantages over existing insect trap designs. The improved insect trap provides a lower cost and a lower weight option to existing designs, while still providing a high capture-rate. Additionally, the improved insect trap can have a uniform wall thickness that provides for easier tooling and material versatility during the manufacturing process. In one embodiment, the exterior wall surfaces have a greater coefficient of friction than the interior surfaces. Also, the present design provides for a fully nestable trap that reduces the overall size of packaging required for shipping the insect trap.

As described herein, an insect trap may refer to any such device suitable for capturing and trapping various insects, arachnids and other similar pests for later disposal. For example, insect traps may include traps designed to capture walking insects and arachnids such as ants, bed bugs, cockroaches, spiders, beetles, and other similar walking insects. Similarly an insect trap may be used to capture flying insects and pests such as bees, wasps, stinkbugs, hornets, mosquitos, flies, and other similar flying pests. Examples of insect traps, including several detailed examples of traps for capturing crawling insects such as bed bugs, can be found in pending U.S. patent application Ser. No. 13/673,299 entitled “Bug Interception Device” and filed on Nov. 9, 2012, the content of which is hereby incorporated by reference in its entirety.

Additionally, it should be noted that while chemical and glue based insect traps are described herein, they are provided merely by way of example, and additional traps such as mechanical traps may be used.

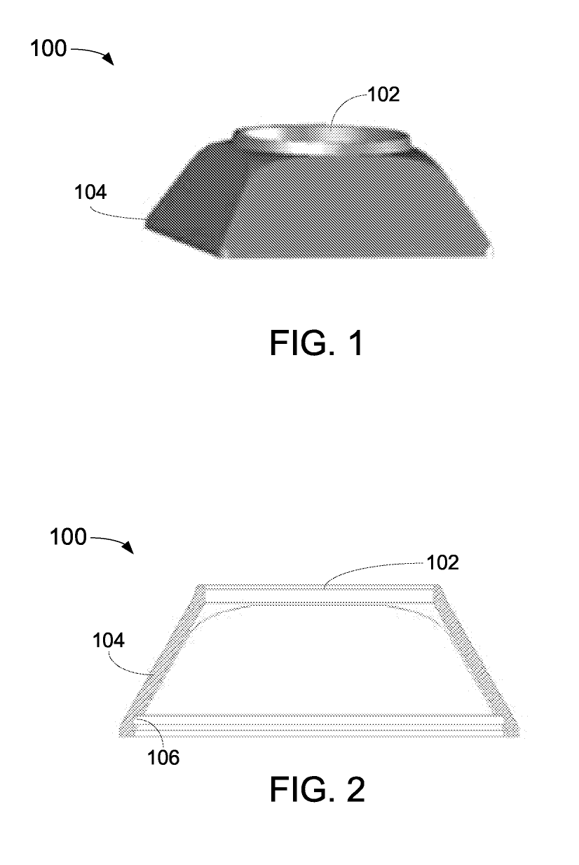

FIG. 1 illustrates an example insect trap 100 that includes a circular inlet 102 and a hollow body 104. As shown in FIG. 1, the body 104 can have a truncated pyramidal shape, including inwardly sloping or inverted walls. In a particular example, the body 104 can include four body sides. However, this is shown by way of example only, and additional shapes for the body 104, such as a truncated tetrahedron shape or a truncated cone shape, can be incorporated. Similarly, the inlet 102 is shown having a circular aperture. This is also shown by way of example only, and additional shapes, such as a square or other polygonal shape, can be used for the inlet 102.

FIG. 2 illustrates a cutaway view of the insect trap 100 as shown in FIG. 1. As shown in FIG. 2, the inverted walls of body 104 define a single interior atrium for capturing and containing the insects. The specific slant of the body 104 defining an acute angle can help to prevent any trapped insects from climbing the walls in order to exit the trap 100 via the inlet 102.

Additionally, the body 104 can include an attachment point 106 for removably attaching a modular floor component for the insect trap 100. For example, as shown in FIG. 2, the attachment point 106 can include a snap joint bead shaped as a circular detent integrally molded into the body 104. It should be noted that the snap joint bead as shown in FIG. 2 is by way of example only, and additional designs for attachment point 106 can be used. In one embodiment, a second set of attachment points for attaching the floor component to the body are formed integrally along the perimeter of the floor component and the body attachment points and floor attachment points are configured to cooperate with each other to attach the floor component to the body. In other exemplary embodiments, an adhesive fastener can be used, a screw-in or screw-on fastener can be used, a slot/lip fastener can be used, a friction-fit fastener can be used, and other similar fasteners that would provide for the floor component to be removable from the body can be used.

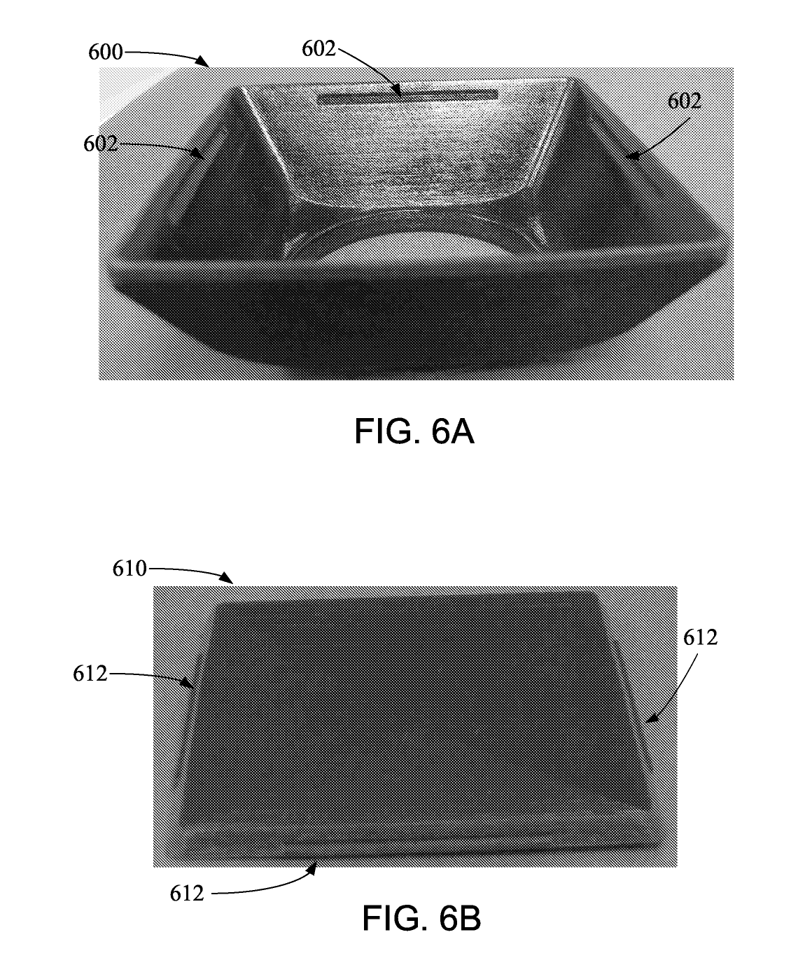

FIG. 6A shows a photograph of an insect trap body 600 according to the present paragraph, similar to insect trap body 104 as described above, shown in an inverted position such that the bottom of the body 600 is upwardly positioned. The insect trap body 600 includes various attachment points 602 for attachment of a floor component. The floor component can be opaque, transparent or translucent. As shown in FIG. 6A, the attachment points 602 can be grooves or slots that are cut, etched, or molded into the insect trap body 602 during manufacture, the attachment points positioned and configured to receive a fastening feature of the floor component.

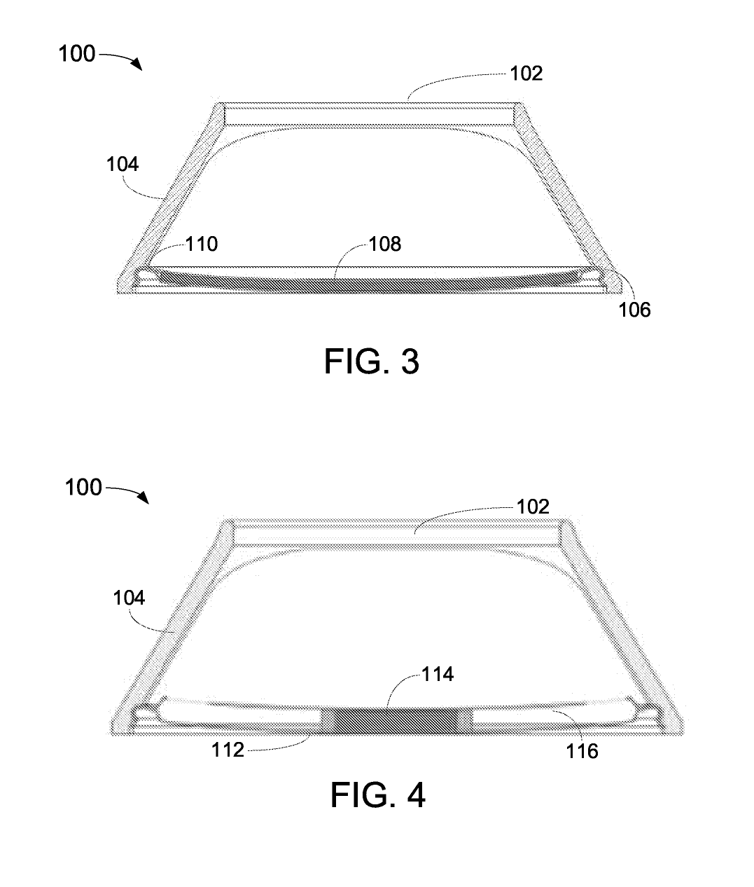

As shown in FIG. 3, a removable floor component 108 can be inserted into the insect trap 100, fastened to the trap at the attachment point 106. As shown in FIG. 3, the removable floor component can include a fastener 110 configured to contact and removably attach to the attachment point 106, thereby holding the removable floor component 108 to the trap 100. As shown in FIG. 3, the fastener 110 can be a lure-shaped fastener positioned and configured to be inserted into the attachment point 106. The shape of the removable floor component 108 can be designed such that a force is exerted outwards through the fastener 110 and against the attachment point 106, thereby holding the removable floor component 108 securely in place. Similarly, the actual design of the body 104 walls may exert a force upon the floor 108, holding the floor in place. In one embodiment, the floor component has a concave shape, so that said interior surface slopes downwardly towards a central focal point. In another embodiment, the interior surface includes a textured surface surrounding the focal point.

As shown in FIG. 3, the removable floor component 108 can include a chemical reservoir including an amount of poison for killing any insects that enter the trap 100. By providing a removable and replaceable floor component 108, the trap 100 can be emptied by removing the floor and emptying the trap of any trapped insects. A new removable floor component can then be inserted, effectively providing a new insect trap while reusing the inlet 102 and the body 104. Such a design reduces overall waste associated with the insect trap 100, while maintaining a high level of usefulness and effectiveness.

FIG. 6B shows a photograph of an removable floor component 610 according to the present paragraph for use with insect trap body 600 as described above. The floor component 610 includes multiple fastening features 612 positioned and configured to fit within attachment points 602 of the trap body 600. As shown in FIG. 6B, the fastening features 612 are small protrusions molded or otherwise formed to the floor component 610 for insertion into the attachment points 602. The design and shape of both the body 600 and the floor 610 can result in a tight fit between the components such that the fastening features 612 are held tightly within the attachment points 602 while still providing a means for removing the floor component from the trap body. In this manner, the floor component 610 can be removed and replaced with a new or a previously cleaned floor component while the trap body 600 is reused.

It should be noted that the specific design of the trap body 600 and the floor component 610 as shown in FIGS. 6A and 6B are shown by way of example only to illustrate a specific embodiment of the attachment points and the fastening features. Additional configurations, such as those described herein in greater detail, can be used as well for removable attaching the floor component to the insect trap body.

Alternatively, as shown in FIG. 4, a differently configured removable floor component 112 can be used with the insect trap 100. For example, the removable floor component 112 can include a smaller chemical reservoir 114 for holding a poison or other chemical such as an odor emitting chemical designed to attract insects into the trap 100. An amount of glue 116 can be applied around the reservoir 114, providing an additional means for trapping the insects within the trap 100.

It should be noted that the two removable floor components 108, 112 as shown in FIGS. 3 and 4 are shown by way of example only, and additional types of floor components can be used. Floor components types include, but are not limited to, passive floors, active floors including baits and/or lures, glue floors, electronic floor components including active monitoring or RFID devices, and other similar types of insect and pest trap floors.

Additionally, like the floor component 610 shown in FIG. 6B, a floor component can be manufactured without any specific features for capturing insects. Specific features, such as glue, poison(s), an odor emitting lure, and the like, can then be applied after the trap is placed. For example, an odor emitting lure may come packaged in a single-use packaging, and be sized and configured appropriately for easy opening and application onto the floor component. By providing a floor component where the specific features for luring and/or killing the insects may be easily changed, the overall usefulness and versatility of the inset trap is improved.

In one embodiment, the single use package includes an absorbent material and one or more insect trapping compositions absorbed thereon. The package has a barrier layer, such as an acrylonitrile-methyl acrylate polymer, to prevent release of the insect trapping composition. Suitable absorbent materials include absorbent polymeric materials or an absorbent fiber mass. Polymeric materials may or may not contain polymeric fibers. Polymeric and non-polymeric fiber materials may be woven or non-woven. Insect trapping compositions include pressure sensitive adhesives, poisons and odor emitting insect lures. In one embodiment, the odor emitting insect lure contains 1-Nonanal, L-lactic acid, 1-octen-3-ol and spearmint oil.

As described herein, the same body and inlet design may be used in concert with multiple floor components based upon a consumer's needs. For example, in a kitchen where using a trap with poison may be a health violation, a floor component such as that shown in FIG. 4, having an odor emitting chemical and a surrounding glue area can be used. Conversely, in an environment where poison can be used (e.g. a mechanical room for a hotel or commercial building) a trap using a removable floor component that has an applied amount of poison can be used. However in any scenario the same body and inlet design can be used for the insect trap, improving the overall usefulness of the insect trap.

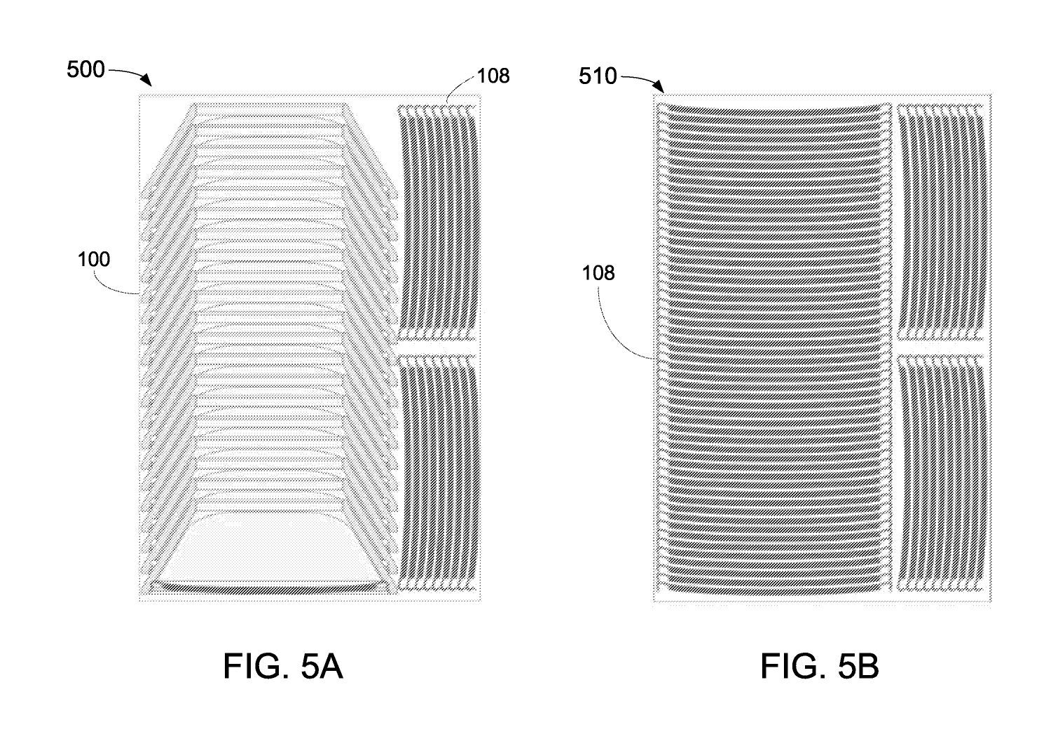

The modular and nestable design for an insect trap as disclosed herein provides for improved packaging of the insect traps as well. As shown in FIG. 5A, a shipping container 500 can include a stack of about 20 insect traps 100 as well as a number of removable floor components 108. However, as the removable floor components 108 can be replaced for each insect trap 100, a second example of a shipping container 510, as shown in FIG. 5B, can include a large set of replaceable floor components 108. Thus, a consumer can purchase a package 500, including a number of traps 100 and floor components 108, and then, when needed, buy a package 510 of replacement floor components, while reusing the traps 100 previously purchased in package 500. Such an arrangement would result in reduced packaging for shipping the traps, while increasing the usefulness of the traps for the end consumer as there are less necessary purchases and waste associated with using the insect traps.

It should be noted that the packaging arrangements as shown in FIGS. 5A and 5B are shown by way of example only, and are provided merely to show additional advantages of the insect traps described herein.

The insect traps of the present invention may then be used to monitor insects by inserting the absorbent material with an insect trapping composition absorbed thereon into the hollow body of the insect trap of the present invention, and placing the insect trap in a desired location, wherein the insect trapping composition is selected from pressure sensitive adhesives, poisons and odor emitting insect lures.

Various of the above-disclosed and other features and functions, or alternatives thereof, can be combined into many other different systems or applications. Various presently unforeseen or unanticipated alternatives, modifications, variations or improvements therein can be subsequently made by those skilled in the art, each of which is also intended to be encompassed by the disclosed embodiments.

What is claimed is:

1. An insect trap comprising a hollow body with a continuous sidewall and a detachable base defining a truncated pyramid or a truncated cone shape, wherein the apex of said truncated cone or pyramid comprises a top surface defining an inlet communicating the interior of the hollow body with the exterior environment.

2. The insect trap of claim 1, wherein the body is formed of a polymer material selected from the group consisting of polylactide, polyester, polyethylene terephthalate, polyethylene, polyvinyl chloride, polyvinylidene chloride, polypropylene, polystyrene, polyamides, acrylonitrile butadiene styrene, polycarbonate, polyurethane, polyacrylate and a combination thereof.

3. The insect trap of claim 1, wherein the exterior surface of said sidewall has a greater coefficient of friction than the interior surface of said sidewall.

4. The insect trap of claim 1, wherein the body comprises four uniform sides defining a truncated tetrahedron.

5. The insect trap of claim 1, wherein the sidewall has a uniform thickness.

6. The insect trap of claim 1, wherein the inlet is circular or square shaped.

7. The insect trap of claim 1, wherein the detachable base comprises a transparent or translucent polymeric material.

8. The insect trap of claim 1, wherein a first means for attaching the detachable base to said body is formed integrally with said sidewall.

9. The insect trap of claim 7, wherein a second means for attaching the detachable base to said body is formed integrally along the perimeter of said detachable base and configured to cooperate with said first means to attach said detachable base to said sidewall.

10. The insect trap of claim 1, wherein the detachable base comprises an interior surface, an exterior surface and a concave shape, so that said interior surface slopes downwardly towards a central focal point.

11. The insect trap of claim 9, wherein the detachable base further comprises a textured surface area surrounding said focal point.

12. The insect trap of claim 1, wherein said inlet of said body further comprises a flange extending continuously along perimeter of said inlet and upwardly from said top surface of said apex.

13. The insect trap of claim 9, wherein said interior surface of said detachable base further comprises a reservoir.

14. An insect trap package system comprising a plurality of the insect traps of claim 1, wherein the detachable base of each insect trap body is detached from the corresponding body sidewall, the baseless bodies are nested within each other as a stack, and the detached bases are assembled in one or more separate stacks within said package system.

15. An insect trap accessory package comprising an absorbent material and an insect trapping composition absorbed thereon, wherein the insect trap accessory package comprises a barrier layer preventing release of said insect trapping composition, the absorbent material comprises an absorbent polymeric material or an absorbent fiber mass, and said insect trapping composition is selected from the group consisting of pressure sensitive adhesives, poisons, and odor emitting insect lures.

16. The insect trap accessory package of claim 14, wherein the absorbent material comprises a synthetic polymer, a natural fiber or a combination thereof.

17. The insect trap accessory package of claim 14, wherein the barrier layer comprises an acrylonitrile-methyl acrylate polymer.

18. A method for monitoring insects comprising inserting an absorbent material with an insect trapping composition absorbed thereon, wherein the absorbent material comprises an absorbent polymeric material or an absorbent fiber mass and said insect trapping composition is selected from the group consisting of pressure sensitive adhesives, poisons, and odor emitting insect lures, into the hollow body of the insect trap of claim 1 and placing said insect trap in a desired location.

19. An insect trap kit comprising the insect trap of claim 1, an absorbent material with an insect trapping composition absorbed thereon, wherein the absorbent material comprises an absorbent polymeric material or an absorbent fiber mass and said insect trapping composition is selected from the group consisting of pressure sensitive adhesives, poisons, and odor emitting insect lures, and instructions for use of the insect trap.
